(19) United States
(12) Patent Application Publication
(10) Pub. No.: US 2007/0165412 A1
(43) Pub. Date: Jul. 19, 2007

(54) Light-emitting-diode light holder assembly

(76) Inventor: Chu-Hsien Lin, Hsin-Chu City (TW)

Correspondence Address: BRUCE H. TROXELL;SUITE 1404, 5205 LEESBURG PIKE, FALLS CHURCH, VA, 22041, US

(21) Appl. No.: 11/333,405

(22) Filed: Jan. 18, 2006

(51) Int. Cl. F21V 15/00

(52) U.S. Cl. 362/362

(57) ABSTRACT

An LED light holder assembly enabling easy mounting of an LED light on a lighting fixture includes an LED light holder and two elastic terminals serving as two power outputs. The light holder has two curve-profiled terminals fixedly provided at two opposite sides of the light holder. Each of the two elastic terminals is connected at an end to a circuit board, and has an annular free end for press contacting with the curve-profiled terminals. When the light holder is positioned between the two elastic terminals, the curve-profiled terminals on the light holder are in press contact with and electrically connected to the annular free ends of the elastic terminals, such that the LED light holder can be easily mounted to and removed from the circuit board and conveniently turned to regulate the light projecting direction of the LED light mounted thereon.

### FIELD OF THE INVENTION

The present invention relates to a light-emitting-diode (LED) light holder assembly, which can be easily mounted to and removed from a lighting fixture to allow the use of an LED light as a light source for lighting fixtures.

### BACKGROUND OF THE INVENTION

Incandescent bulbs, quartz bulbs, fluorescent bulbs, and mercury lamps are most frequently used on daily lighting fixtures as light sources. All these bulbs or lamps are not adjustable to change the light projecting directions thereof once they are installed on the lighting fixtures. Therefore, a user has to take the areas to be illuminated into consideration at the very beginning of mounting the lighting fixtures. When it is desired to project the light of a lighting fixture to different illuminating areas, the user has only one choice, that is, to change the mounting position of the lighting fixture. To do so, the user might have to troublesomely re-arrange the wires for the lighting fixture or drill new or additional holes on walls or ceilings.

The light-emitting diode (LED) has the advantages of low power consumption, high illuminating efficiency, and small volume, and is frequently used as an indicator light in a circuit. Later, LED lights are also frequently used on large-scale electronic advertising signboards and traffic signal lamps, particularly the signal lamps at pedestrian crosswalks. Recently, the LED lights have also been used on lamps of some high class cars as light sources. In all the above-mentioned applications of LED lights, the LED lights are fixedly welded to a circuit board of a lighting appliance. In the event any one of the LED lights on the circuit board is damaged, the whole lighting appliance must be replaced with a new one to show perfect lighting effect. It is apparently not economical to discard the non-damaged LED lights on the circuit board of the lighting appliance. That is why one may frequently find many advertising signboards and traffic signal lamps showing incompletely illuminated areas due to some damaged LED lights thereof. For these reasons, the LED lights have not yet been widely used on most lighting fixtures used in our daily life.

### SUMMARY OF THE INVENTION

A primary object of the present invention is to provide an LED light holder assembly for easily mounting and removing an LED light to and from lighting fixtures.

Another object of the present invention is to provide an LED light holder assembly that allows an LED light mounted thereon to be easily adjusted to different light projecting directions.

A further object of the present invention is to provide an LED light holder assembly that could be easily assembled and disassembled to facilitate installation and maintenance thereof.

To achieve the above and other objects, the LED light holder assembly of the present invention includes an LED light holder and two elastic terminals serving as two power outputs. The light holder has two curve-profiled terminals fixedly provided at two opposite sides of the light holder. Each of the two elastic terminals is connected at an end to a circuit board, and has a free end formed into an annular contact for press contacting with the curve-profiled terminals. When the light holder is positioned between the two elastic terminals, the curve-profiled terminals on the light holder are in press contact with and electrically connected to the annular free ends of the elastic terminals.

In the LED light holder assembly of the present invention, the curve-profiled terminals on the LED light holder are partially protruded through the annular contacts at the free ends of the two elastic terminals, so that the annular contacts of the elastic terminals also serve to support the LED light holder thereon.

In the LED light holder assembly of the present invention, when the LED light holder is mounted between the two elastic terminals, it can be conveniently turned to regulate the light projecting direction of the LED light mounted thereon.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an LED light holder assembly according to a first embodiment of the present invention;

FIG. 2 is a sectional view of FIG. 1;

FIG. 3 is an enlarged perspective view of an elastic terminal included in the LED light holder assembly of FIG. 1;

FIG. 4 is a sectional view of an LED light holder assembly according to a second embodiment of the present invention;

FIG. 5 is a perspective view of an LED light holder assembly according to a third embodiment of the present invention;

FIG. 6 is a sectional view of FIG. 5; and

FIG. 7 is a sectional view of an LED light holder assembly according to a fourth embodiment of the present invention.

### DETAILED DESCRIPTION OF THE PREFERRED EMBODIMENTS

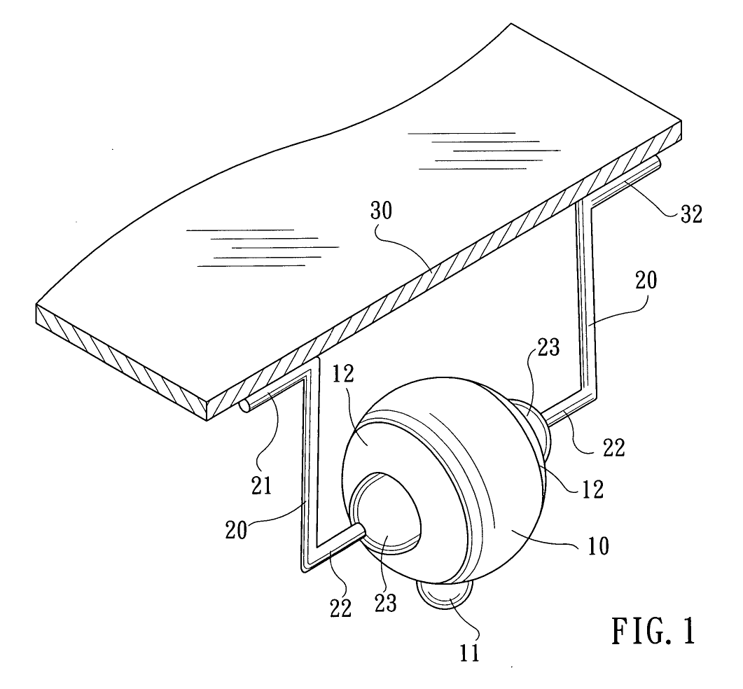

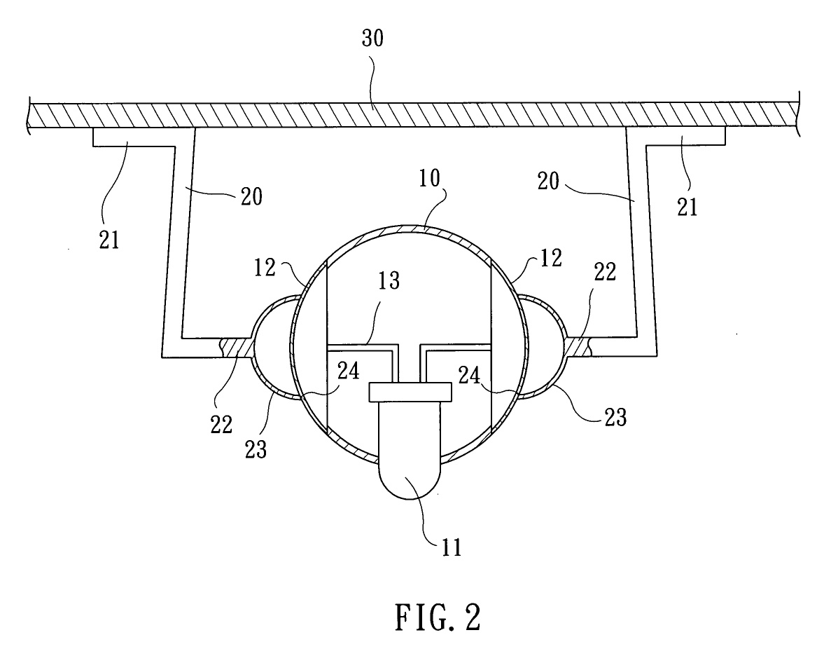

Please refer to FIGS. 1 and 2 that are perspective and sectional views, respectively, of an LED light holder assembly according to a first embodiment of the present invention. As shown, the LED light holder assembly in the first embodiment includes an LED light holder 10 and two elastic terminal 20 served as two power outputs. At least one LED light 11 is mounted on the LED light holder 10 to serve as a light source. The light holder 10 is a spherical member having two spherical terminals 12 fixedly provided at two opposite sides thereof for serving as two power inputs of the LED light holder 10. And, the two spherical terminals 12 have outer surfaces located on the same sphere. Each of the two elastic terminals 20 is fixedly connected at an end 21 to a circuit board 30, and at the other free end 22 to a cup 23. Each of the cups 23 defines at an open end an annular rim 24. The LED light holder 10 is positioned between and clamped by the two elastic terminals 20 with the two spherical terminals 12 outward protruded into the two cups 23, such that the spherical terminals 12 are in press contact with and electrically connected to the annular rims 24 of the cups 23.

The LED light 11 is provided at a top with two pins 13 to serve as power inputs. The two spherical terminals 12 on the LED light holder 10 are separately welded to the two pins 13. With the above arrangements, the LED light holder 10 could be rotated between the two elastic terminals 20 to regulate the light projecting direction of the LED light 11.

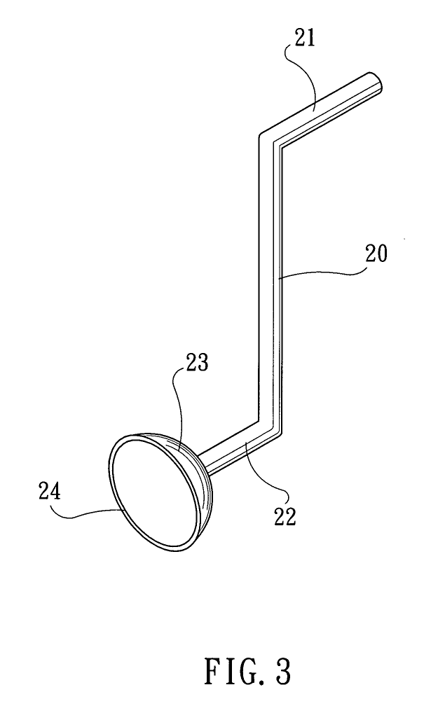

Before the LED light holder 10 is positioned between the two cups 23, a distance between the two annular rims 24 of the cups 23 connected to the free ends 22 of the two elastic terminals 20 is slightly smaller than a diameter of the spherical LED light holder 10. When the LED light holder 10 is positioned between the two cups 23, the annular rims 24 of the two elastic terminals 20 are forced apart to thereby produce an elastic restoring force to firmly clamp the LED light holder 10 therebetween. FIG. 3 is an enlarged perspective view showing the elastic terminal 20 and the cup 23 connected to the free end 22 of the elastic terminal 20.

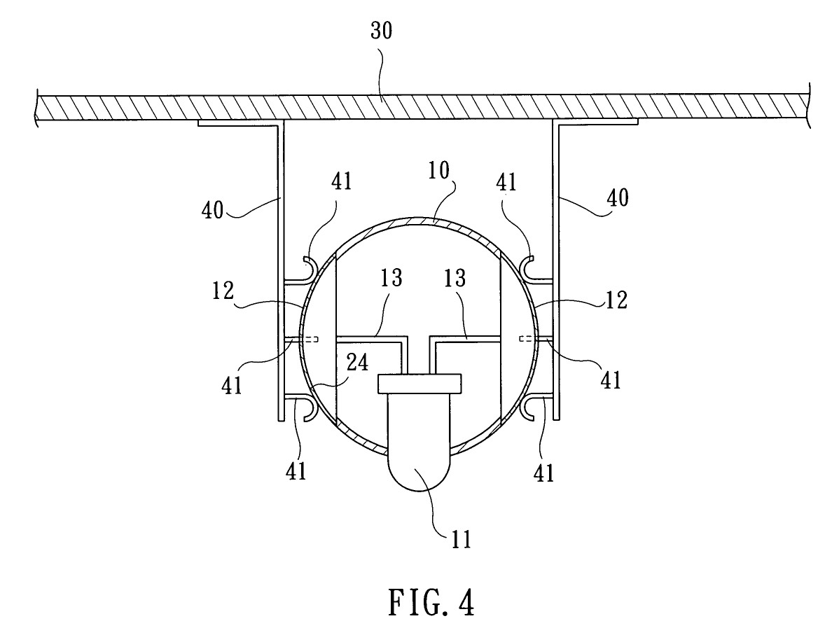

FIG. 4 is a sectional view of an LED light holder assembly according to a second embodiment of the present invention. The second embodiment is different from the first embodiment in two plate-shaped elastic terminals 40. The elastic terminals 40 are provided on two opposite inner sides with three or four angularly equally spaced and inward protruded strips 41 having a radially outward curved distal end each. When the LED light holder 10 is positioned and clamped between the two elastic terminals 40, the two spherical terminals 12 on the light holder 10 are separately protruded into a space enclosed in the protruded strips 41 on the inner side of each elastic terminal 40, preventing the LED light holder 10 from dropping off the elastic terminals 40 while keeping the two spherical terminals 12 in press contact with the elastic terminals 40.

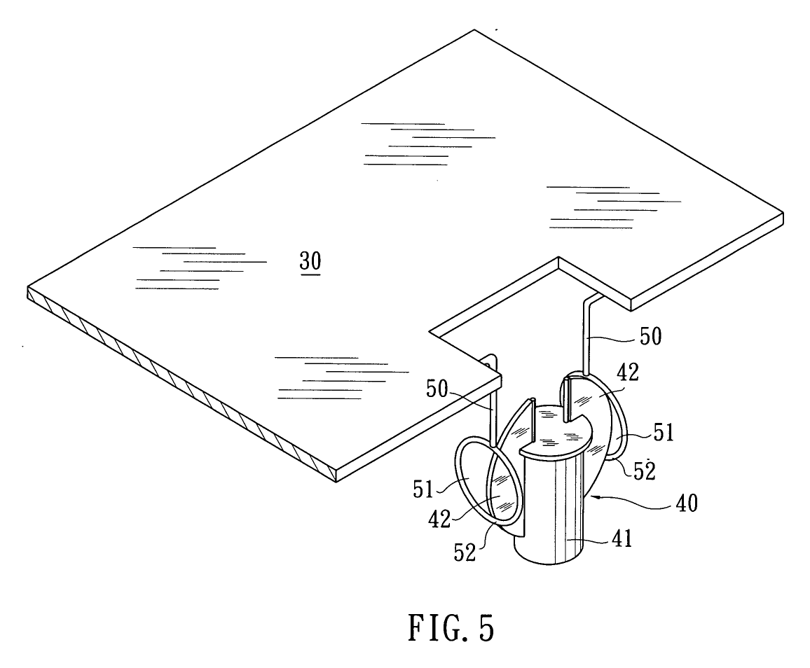

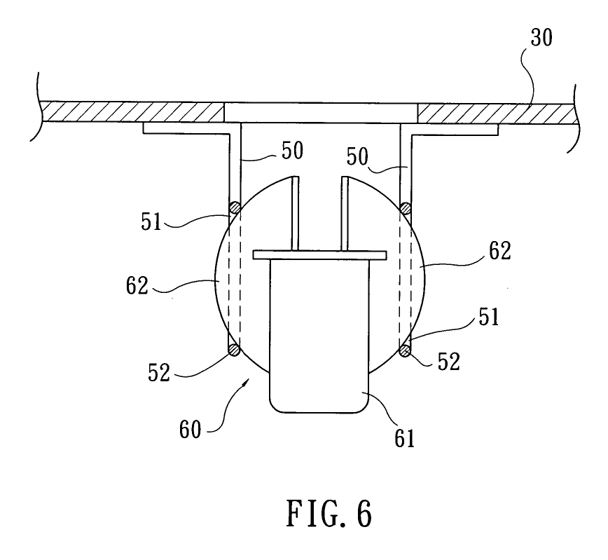

FIGS. 5 and 6 are perspective and sectional views, respectively, of an LED light holder assembly according to a third embodiment of the present invention. The third embodiment includes an LED light holder 60 for holding an LED light 61 thereto. The LED light holder 60 consists of two opposite, plate-shaped, and curve-profiled terminals 62 serving as two power inputs of the light holder 60. Each of the curve-profiled terminals 62 has a curved outer edge and a straight inner edge each. The curved outer edges of the two plate-shaped terminals 62 are located on the same circumference. Two elastic terminals 50 are respectively fixedly connected at an end to a circuit board 30 and have a free end each formed into a ring 52 defining a central opening 51. The LED light holder 60 is located between and clamped by the two elastic terminals 50 with the curved outer edges of the two plated-shaped terminals 62 protruded into the central openings 51 of the ring-shaped free ends 52 of the two elastic terminals 50. With these arrangements, the LED light holder 60 could be pivotally turned forward or rearward, or leftward or rightward relative to the two elastic terminals 50 for regulating the light projecting direction of the LED 61 mounted thereon.

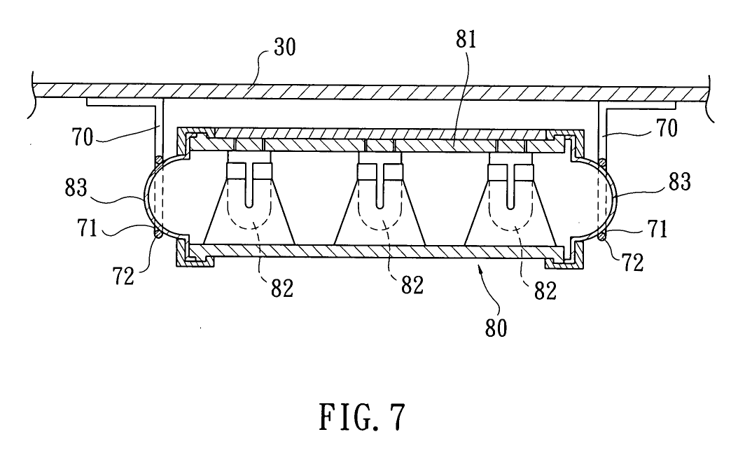

FIG. 7 is a sectional view of an LED light holder assembly according to a fourth embodiment of the present invention. The fourth embodiment includes an LED light holder 80 being internally provided with a circuit board 81 and at least one LED light 82, and having two spherical terminals 83 fixed to two opposite ends of the LED light holder 80 to serve as two power inputs of the circuit board 81. Two elastic terminals 70 are respectively fixedly connected at an end to a circuit board 30, and have an opposite free end each formed into a ring 72 defining a central opening 71. The LED light holder 80 is positioned between and clamped by the two elastic terminals 70 with the two spherical terminals 83 at two opposite ends of the light holder 80 outward and sideward protruded into the central openings 71 at the ring-shaped free ends 72 of the elastic terminals 70 to press contact with and electrically connect to the ring-shaped free ends 72. With these arrangements, the LED light holder 80 could be pivotally turned to regulate the light projecting direction of the LED lights 81 in the light holder 80.

The LED light holder assembly of the present invention can be more easily installed and replaced, and allows regulation of the light projecting direction of the LED light mounted on the LED light holder, and is therefore very practical for use on daily lighting fixtures.

What is claimed is:

1. An LED light holder assembly, comprising a light holder and two elastic terminals serving as two power outputs;
said light holder having at least one LED light mounted thereon, and including two curve-profiled terminals formed at two opposite sides thereof to serve as two power inputs of said light holder; and
said elastic terminals being separately connected at an end to a circuit board, and at a free end connected to a cup each, and each of said cups having an outer end defining an annular rim; and
said light holder being clamped by and between said free ends of said two elastic terminals with said two curve-profiled terminals at two opposite sides of said light holder in press contact with said annular rims of said two cups connected to the free ends of said two elastic terminals.

2. The LED light holder assembly as claimed in claim 1, wherein said light holder is a spherical member.

3. The LED light holder assembly as claimed in claim 1, wherein said two curve-profiled terminals on said light holder are spherical terminals.

4. An LED light holder assembly, comprising a light holder, and two elastic terminals serving as two power outputs;
said light holder having at least one LED light mounted thereon, and including two curve-profiled terminals formed at two opposite sides thereof to serve as two power inputs of said light holder; and
said elastic terminals being separately connected at an end to a circuit board, and having a plate-shaped free end each; said two elastic terminals being provided on two opposite inner sides of said plate-shaped free ends with three or four angularly equally spaced and inward protruded strips having a radially outward curved distal end each; and
said light holder being clamped by and between said free ends of said two elastic terminals with said two curve-profiled terminals at two opposite sides of said light holder outward protruded into a space enclosed in the protruded strips on the inner side of each elastic terminal, preventing said light holder from dropping off said elastic terminals.

5. The LED light holder assembly as claimed in claim 4, wherein said light holder is a spherical member.

6. The LED light holder assembly as claimed in claim 4, wherein said two curve-profiled terminals on said light holder are spherical terminals.

7. An LED light holder assembly, comprising a light holder, and two elastic terminals serving as two power outputs;
said light holder having at least one LED light mounted thereon, and including two curve-profiled terminals formed at two opposite sides thereof to serve as two power inputs of said light holder; and
said elastic terminals being separately connected at an end to a circuit board, and having a free end each formed into a ring defining a central opening; and
said light holder being clamped by and between said free ends of said two elastic terminals with said two curve-profiled terminals at two opposite sides of said light holder outward protruded into said central openings of said ring-shaped free ends of said two elastic terminals to press contact with said ring-shaped free ends.

8. The LED light holder assembly as claimed in claim 7, wherein said two curve-profiled terminals on said light holder are two plate-shaped terminals, two curved outer edges of which are located on the same circumference.
